(19) United States
(12) Patent Application Publication
(10) Pub. No.: US 2026/0118109 A1
(43) Pub. Date: Apr. 30, 2026

(54) DEVICE AND METHOD FOR MONITORING AND EARLT WARNING OF CABLE DEFORMATION

(71) Applicant: Guilin University of Technology, Guilin (CN)

(72) Inventors: Guoqing Zhou, Guilin (CN); Wei Liu, Guilin (CN); Jiasheng Xu, Guilin (CN)

(21) Appl. No.: 19/230,134

(22) Filed: Jun. 6, 2025

(30) Foreign Application Priority Data
Oct. 27, 2024 (CN) 202411504898.6

(51) Int. Cl. G01B 7/16; G08B 25/01

(52) U.S. Cl. CPC G01B 7/18; G08B 25/018

(57) ABSTRACT

A method for monitoring and early warning of cable deformation includes: installing slave stations at respective monitoring points in a cable network in accordance with an order of identification numbers of the slave stations; transmitting, through a housing, a cable length change in a form of tension to an elastic conductor when a cable is subjected to an external force; monitoring, by each of the slave stations, a change in a resistance value of the elastic conductor to indirectly monitor the cable, and sending, by one of the slave stations, an early warning signal with a corresponding one of the identification numbers to a master station when the change in the resistance value of the elastic conductor of the one of the slave stations exceeds a preset range; and receiving, by the master station, the early warning signal from the one of the slave stations via a self-organizing network.

### CROSS-REFERENCE TO RELATED APPLICATION

This application claims priority to Chinese Patent Application No. 202411504898.6, filed on Oct. 27, 2024, which is herein incorporated by reference in its entirety.

### TECHNICAL FIELD

The disclosure relates to the field of cable monitoring and early warning, and more particularly to monitoring and early warning of cable deformation.

### BACKGROUND

Cables, serving as “arteries” and “nerves” of modern society, are sometimes subjected to external damages, such as winter condensation and icing, or displacement of electric transmission towers, which can cause insulation layer damage and conductor breakage, resulting in regional power outages and affecting normal social production and life. Various enterprises and organizations have conducted numerous studies on the protection and monitoring of cables.

Luo Yizhao et al. discloses a Chinese patent “Cable Running State Inspection Robot” with publication number CN118198931A. The robot operates along a guide rail and identifies cable surface damage through a monitoring assembly, then drives a repair assembly to fix the damaged surface. However, the application of the robot is highly limited, as the robot requires the installation of additional guide rails and is unable to predict imminent damage.

A paper titled “Guarding MV cables on-line: With travelling wave based temperature monitoring, fault location, PD location and PD related remaining life aspects” by Fred Steennis et al. describes a monitoring method including: detecting partial discharges and rapidly locating faults in medium-voltage cables, and achieving a precision within 1% of cable length. However, when applied to paper insulated lead covered (PILC) cables, this monitoring method may fail to provide timely warnings due to the self-healing properties of PILC cables.

Shen Dilong et al. discloses a Chinese patent “a cable monitoring and early warning system and method based on stress waves” with publication number CN117970031A. This patent involves transmitting pulse signals to a cable through a pulse signal emission module and receiving the pulse signals with a receiving module. The qualification of the cable is determined by calculating a pulse propagation time. However, due to the limitations of its equipment, this method can only be used for product monitoring in a factory and is not suitable for monitoring and early warning of cables in operation.

A paper titled “On-line monitoring system of 35 kV 3-core submarine power cable based on φ-OTDR” by Anqiang Lv et al. proposes a method for detecting anchor damage in submarine power cables using phase sensitive time domain reflectometry (φ-OTDR). This method solves a problem of submarine cables being vulnerable to anchor damage yet difficult to monitor effectively. This paper conducts simulations of anchor-dragging and anchor-dragging events and acquired and analyzed vibration data under conditions of calm sea, anchor-dropping, and anchor-dragging resistance. However, this solution is still immature and requires further research.

Huang Yingmin et al. discloses a Chinese patent “Overhead Cable Protection Device and Method” with publication number CN118040533A. This patent combines a vibration monitoring module, a camera, and a drone to create an integrated cable protection system that performs vibration data collection, image data acquisition, and drone-based deterrence. However, the proposed system may require a more advanced artificial intelligence (AI) system or continuous human monitoring.

A paper titled “Design of Underground Cable Anti-External-Damage Monitoring and Early Warning System Based on Wireless Intelligent Vibration Sensors” by Tang Xianghua et al. designs a wireless intelligent vibration collection system to solve a problem of excavation-induced damage to underground cables, which affects the operation of cable systems. This wireless intelligent vibration collection system performs feature analysis and extraction on collected vibration signals to achieve early warning of excavation damage to the underground cables. However, challenges of feature extraction and recognition are significant due to a smaller propagation radius and a faster attenuation of vibrations generated by excavation in an underground environment.

From the above content, it can be seen that the focus in the related art is on locating positions where damage has already occurred, and it is difficult to provide an early warning for damage that has not yet occurred.

### SUMMARY

To solve the above problems, the disclosure provides a device and a method for monitoring and early warning of cable deformation, which belongs to the field of cable deformation monitoring and early warning. Targeting problems such as cable insulation layer damage and conductor breakage caused by winter condensation and icing or displacement of electric transmission towers, the device and the method for monitoring and early warning of cable deformation are proposed. The device includes a master station and N number of slave stations, and each of the N number of slave stations includes a housing, an elastic conductor, a main control board, a wireless communication module, an antenna, a battery and a photovoltaic panel. Specifically, the method for monitoring and early warning of cable deformation includes:
installing N number of slave stations at respective monitoring points in a cable network in accordance with an order of identification numbers of the N number of slave stations, where each of the N number of slave stations includes a housing, an elastic conductor, a main control board, a wireless communication module, an antenna, a battery and a photovoltaic panel;
transmitting, through the housing, a cable length change in a form of tension to the elastic conductor to thereby make a change in a resistance value of the elastic conductor when a cable is subjected to an external force causing the cable length change;
monitoring, by each of the N number of slave stations, the change in the resistance value of the elastic conductor to indirectly monitor the cable, and sending, by one of the N number of slave stations, an early warning signal with a corresponding one of the identification numbers to the master station when the change in the resistance value of the elastic conductor of the one of the N number of slave stations exceeds a preset range; and
receiving, by the master station, the early warning signal from the one of the N number of slave stations via a self-organizing network, and identifying, by the master station, position coordinates of the one of the N number of slave stations according to the corresponding one of the identification numbers, wherein the master station is a communication master station.

In an embodiment, the device is designed to be lightweight and compact, and the device is powered using solar energy to achieve long-term uninterrupted monitoring and early warning.

In an embodiment, the wireless communication module is embodied by at least one processor and at least one memory coupled to the at least one processor, and the at least one memory stores computer programs executable by the at least one processor. For example, the wireless communication module may include a wireless transceiver. Moreover, the wireless communication module can be a long range (LoRa) module or a 4G/5G module.

The technical solution can be implemented as follows.

The device for monitoring and early warning of cable deformation includes the master station and the N number of slave stations. The master station is configured to receive early warning signals sent by the N number of slave stations, and to identify position coordinates of the N number of slave stations according to corresponding identification numbers. Each of the N number of slave stations is configured to monitor cable deformation. When a deformation value of the cable monitored by the one of the N number of slave stations exceeds a threshold, the one of the N number of slave stations is configured to send the early warning signal with the corresponding one of the identification numbers to the master station, thereby achieving an early warning effect.

In an embodiment, the master station is the communication master station, which receives the early warning signals sent by the N number of slave stations via the self-organizing network.

In an embodiment, each of the N number of slave stations includes the housing, the elastic conductor, the main control board, the wireless communication module, the antenna, the battery and the photovoltaic panel.

In an embodiment, the housing is made of a flexible material and satisfies a formula (1) to ensure a continuous monitoring on a deformation range of the cable:

$${E}_{W} < {E}_{D} \qquad ( 1 )$$

where E_{W} represents an elastic modulus of the flexible material of the housing, and E_{D} represents an elastic modulus of the cable.

In an embodiment, the monitoring, by each of the N number of slave stations, the change in the resistance value of the elastic conductor to indirectly monitor the cable includes:
acquiring, via a circuit measurement, the change in the resistance value of the elastic conductor to monitor deformation of the cable when the elastic conductor is deformed, where the elastic conductor satisfies a formula (2), when the elastic conductor is deformed with the housing, a length and a cross-sectional area of the elastic conductor are changed to thereby make the change in the resistance value of the elastic conductor, and the formula (2) is as follows:

$$Δ R / {R}_{0} = ( Δ L / {L}_{0} ) ρ \qquad ( 2 )$$

where ΔR represents a resistance change value of the elastic conductor, R₀ represents an initial resistance value of the elastic conductor, ΔL represents a length change value of the elastic conductor, L₀ represents an initial length value of the elastic conductor, and ρ represents a sensitivity coefficient.

In an embodiment, the elastic conductor is positioned with the housing by using locating pins and is also connected to the housing with an adhesive to ensure that deformation of the housing is accurately reflected in the elastic conductor.

In an embodiment, the monitoring, by each of the N number of slave stations, the change in the resistance value of the elastic conductor to indirectly monitor the cable, and sending, by one of the N number of slave stations, an early warning signal with a corresponding one of the identification numbers to a master station when the change in the resistance value of the elastic conductor of the one of the N number of slave stations exceeds a preset range includes:
monitoring, by the main control board, the change in the resistance value of the elastic conductor, and commanding, by the main control board, the wireless communication module to send the early warning signal with the corresponding one of the identification numbers and a corresponding abnormal resistance value to the master station when the resistance value of the elastic conductor is abnormal, where the early warning signal is sent at time intervals; and
collecting temperature data by a temperature sensor integrated on the main control board to improve accuracy of the early warning signal when the N number of slave stations operate in an outdoor environment with an environmental temperature difference.

In an embodiment, the wireless communication module performs communication via the self-organizing network, and establishes a tree network topology, a star network topology, and a mesh network topology to adapt to different transmission environments.

The battery supplies power and cooperates with the photovoltaic panel to provide outdoor energy supply, thereby ensuring a long-term stable operation of the N number of slave stations.

An operation process of the method for monitoring and early warning of cable deformation is as follows.

Before the operation of the method for the monitoring and early of cable deformation, the master station and wireless communication modules of the N number of slave stations are arranged to form the self-organizing network based on an installation environment. An operating state of the elastic conductor is debugged to ensure a normal operation of the elastic conductor. Different abnormal ranges are set based on actual materials, dimensions, and other conditions of cables. The N number of slave stations are installed at the respective monitoring points in accordance with the order of the identification numbers of the N number of slave stations.

During the operation of the method for the monitoring and early warning of cable deformation, when the cable is subjected to the external force, the cable undergoes elastic deformation, resulting in a length change of a monitored cable section. A tension (also referred to as tensile force) generated by the cable deformation is transmitted through the housing to the elastic conductor, thereby causing deformation of the elastic conductor. The deformation of the elastic conductor results in the change in the resistance value of the elastic conductor in a circuit. The resistance value of the elastic conductor is monitored by the main control board to monitor the deformation of the cable. When the resistance value of the elastic conductor of the one of the N number of slave stations exceeds the preset range, the early warning signal is sent to the master station by the wireless communication module. Since the N number of slave stations operate in outdoor environments with the larger environmental temperature difference, the temperature sensor is integrated into the main control board to collect the temperature data, thereby enhancing the accuracy of the early warning signal.

Compared to the related art, the disclosure has the following significant advancements.

1. Novelty and creativity: the disclosure is the first to propose monitoring cable deformation through real-time changes in the elastic conductor and sending the early warning signals via the wireless communication module.

2. Early warning capability: the disclosure provides early warning by monitoring cable deformation in real time. It alerts before irreversible damage occurs due to external forces, thereby significantly reducing the losses caused by such damage.

3. Economic efficiency: the disclosure achieves economic efficiency by utilizing strain effects for cable monitoring, sending the early warning signals through the wireless communication module, and using the photovoltaic panel for power supply. Compared to the related art (such as dispatching technicians for periodic inspections or locating faults after irreversible damage has occurred), it greatly conserves human and material resources.

### BRIEF DESCRIPTION OF DRAWINGS

FIG. 1 illustrates a structural diagram of a slave station used in a method for monitoring and early warning of cable deformation according to the disclosure.

FIG. 2 illustrates a schematic diagram of a working principle of the method for monitoring and early warning of cable deformation according to the disclosure.

FIG. 3 illustrates a schematic diagram of a relationship between a master station and slave stations.

FIG. 4 illustrates a schematic diagram of a relationship between a cable and the slave station.

### DESCRIPTION OF REFERENCE SIGNS IN THE DRAWINGS

1—antenna; 2—photovoltaic panel; 3—wireless communication module; 4—battery; 5—main control board; 6—housing; 7—elastic conductor; 8—temperature sensor; 9—locating pin; 10—self-organizing network; L₀—length of monitored cable section under normal condition; L₁—length of monitored cable section when subjected to external force damage.

### DETAILED DESCRIPTION OF EMBODIMENTS

To make purposes, technical solutions, and advantages of the disclosure clearer and more understandable, following specific embodiments are provided, and the specific embodiments of the disclosure are further described in detail in conjunction with attached drawings.

### EMBODIMENT

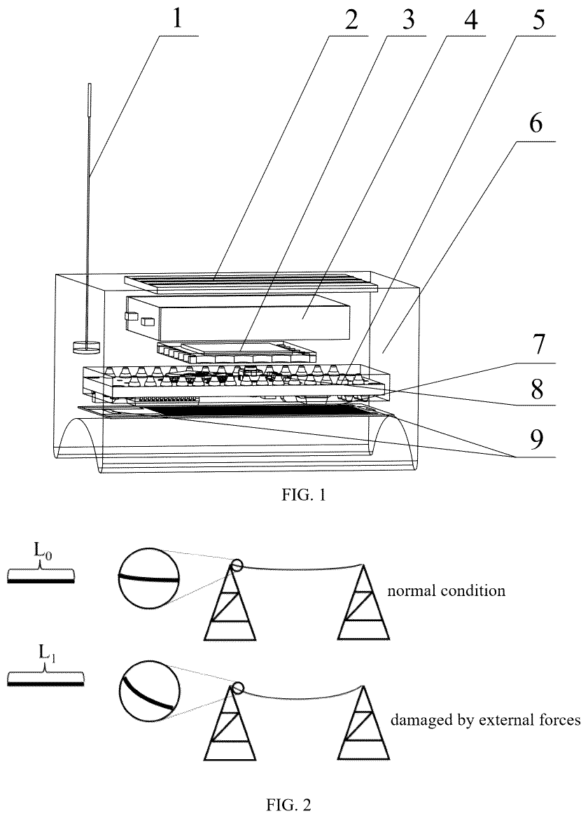

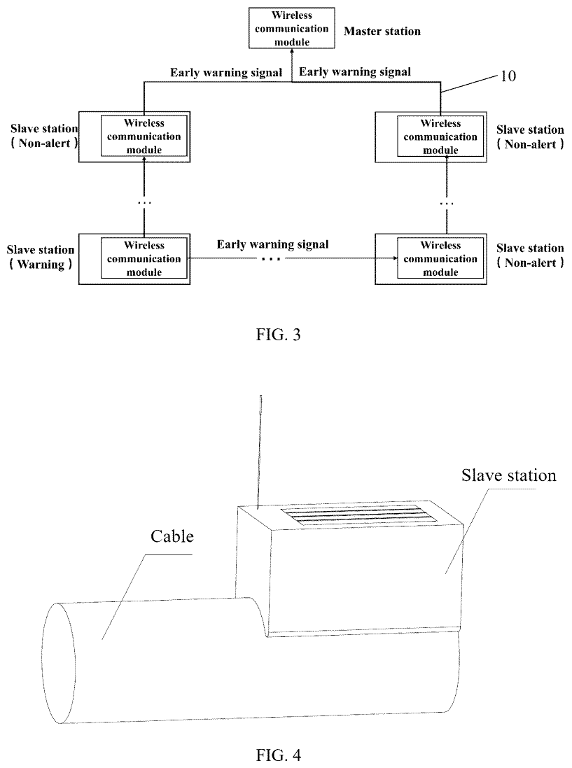

Referring to FIG. 1 through FIG. 4, a device for monitoring and early warning of cable deformation includes a master station and N number of slave stations. The master station is a communication master station. The N number of slave stations are installed at respective monitoring points in a cable network in accordance with an order of identification numbers of the N number of slave stations, and each of the N number of slave stations includes a housing 6, an elastic conductor 7, a main control board 5, a wireless communication module 3, an antenna 1, a battery 4 and a photovoltaic panel 2. As shown in FIG. 4, a cable is in contact with a concave groove at a lower end of each of the N number of slave stations. Therefore, when the cable is subjected to an external force causing a cable length change, the cable length change is transmitted through housing to the elastic conductor in a form of tension to thereby make a change in a resistance value of the elastic conductor. Each of the N number of slave stations is configured to monitor the change in the resistance value of the elastic conductor to indirectly monitor the cable. When the change in the resistance value of the elastic conductor of one of the N number of slave stations exceeds a preset range, the one of the N number of slave stations is configured to send an early warning signal with a corresponding one of the identification numbers to the master station. The master station is configured to receive the early warning signal from the one of the N number of slave stations via a self-organizing network 10, and to identify position coordinates of the one of the N number of slave stations according to the corresponding one of the identification numbers.

In an illustrated implementation, an operation process of a method for monitoring and early warning of cable deformation is as follows.

Before the operation of the method for the monitoring and early warning of cable deformation, the master station and wireless communication modules 3 of the slave stations are arranged to form corresponding self-organizing networks 10 based on different installation environments. An operating state of the elastic conductor 7 is debugged to ensure a normal operation of the elastic conductor 7. Parameters are set based on an actual material, dimensions, and other conditions of cables. The slave stations are installed at the respective monitoring points in accordance with the order of the identification numbers of the slave stations.

During the operation of the method for the monitoring and early warning of cable deformation, a length of a monitored cable section is L₀ under a normal condition. When the cable is subjected to an external force, the cable undergoes elastic deformation, the length of the monitored cable section changes to L₁. A tension generated by the cable deformation is transmitted through the housing 6 to the elastic conductor 7, thereby causing deformation of the elastic conductor 7. The deformation of the elastic conductor 7 results in the change in the resistance value of the elastic conductor 7 in a circuit. The resistance value of the elastic conductor 7 is monitored by the main control board 5 to monitor deformation of the cable. When the resistance value of the elastic conductor 7 of one of the slave stations exceeds the preset range, an early warning signal is sent to the master station by the wireless communication module 3. Since the slave stations operate in outdoor environments with a larger environmental temperature difference, a temperature sensor 8 is integrated into the main control board 5 to collect temperature data, thereby enhancing accuracy of the early warning signal.

Although the specific embodiments of the disclosure have been disclosed above, they are not limited to the applications listed in the specification and embodiments, and can be fully applied to various fields suitable for the disclosure. For those skilled in the art, additional modifications can be easily made. Therefore, without departing from the general concept defined by the claims and their equivalents, the disclosure is not restricted to the specific details and embodiments shown and described herein.

What is claimed is:

1. A method for monitoring and early warning of cable deformation, comprising:
installing N number of slave stations at respective monitoring points in a cable network in accordance with an order of identification numbers of the N number of slave stations, wherein each of the N number of slave stations comprises a housing, an elastic conductor, a main control board, a wireless communication module, an antenna, a battery and a photovoltaic panel;
transmitting, through the housing, a cable length change in a form of tension to the elastic conductor to thereby make a change in a resistance value of the elastic conductor when a cable is subjected to an external force causing the cable length change;
monitoring, by each of the N number of slave stations, the change in the resistance value of the elastic conductor to indirectly monitor the cable, and sending, by one of the N number of slave stations, an early warning signal with a corresponding one of the identification numbers to a master station when the change in the resistance value of the elastic conductor of the one of the N number of slave stations exceeds a preset range; and
receiving, by the master station, the early warning signal from the one of the N number of slave stations via a self-organizing network, and identifying, by the master station, position coordinates of the one of the N number of slave stations according to the corresponding one of the identification numbers, wherein the master station is a communication master station.

2. The method for the monitoring and early warning of cable deformation as claimed in claim 1, wherein the housing is made of a flexible material and satisfies a formula (1) to ensure a continuous monitoring on a deformation range of the cable:
$${E}_{W} < {E}_{D} \qquad ( 1 )$$
where E_{W} represents an elastic modulus of the flexible material of the housing, and E_{D} represents an elastic modulus of the cable.

3. The method for the monitoring and early warning of cable deformation as claimed in claim 1, wherein the monitoring, by each of the N number of slave stations, the change in the resistance value of the elastic conductor to indirectly monitor the cable comprises:
acquiring, via a circuit measurement, the change in the resistance value of the elastic conductor to monitor deformation of the cable when the elastic conductor is deformed, wherein the elastic conductor satisfies a formula (2), when the elastic conductor is deformed along with the housing, a length and a cross-sectional area of the elastic conductor are changed to thereby make the change in the resistance value of the elastic conductor; the elastic conductor is positioned by using locating pins and is connected to the housing with an adhesive to ensure that deformation of the housing is accurately reflected in the elastic conductor, and the formula (2) is as follows:
$$Δ R / {R}_{0} = ( Δ L / {L}_{0} ) ρ \qquad ( 2 )$$
where ΔR represents a resistance change value of the elastic conductor, R₀ represents an initial resistance value of the elastic conductor, ΔL represents a length change value of the elastic conductor, L₀ represents an initial length value of the elastic conductor, and ρ represents a sensitivity coefficient.

4. The method for the monitoring and early warning of cable deformation as claimed in claim 1, wherein the monitoring, by each of the N number of slave stations, the change in the resistance value of the elastic conductor to indirectly monitor the cable, and sending, by one of the N number of slave stations, an early warning signal with a corresponding one of the identification numbers to a master station when the change in the resistance value of the elastic conductor of the one of the N number of slave stations exceeds a preset range comprises:
monitoring, by the main control board, the change in the resistance value of the elastic conductor, and commanding, by the main control board, the wireless communication module to send the early warning signal with the corresponding one of the identification numbers and a corresponding abnormal resistance value to the master station when the resistance value of the elastic conductor is abnormal, wherein the early warning signal is sent at time intervals; and
collecting temperature data by a temperature sensor integrated on the main control board to improve accuracy of the early warning signal when the N number of slave stations operate in an outdoor environment with an environmental temperature difference.

5. The method for the monitoring and early warning of cable deformation as claimed in claim 1, wherein the wireless communication module performs communication via the self-organizing network, and establishes a tree network topology, a star network topology, and a mesh network topology to adapt to different transmission environments.

6. The method for the monitoring and early warning of cable deformation as claimed in claim 1, wherein the battery supplies power and cooperates with the photovoltaic panel to provide outdoor energy supply, thereby ensuring an operation of the N number of slave stations.
